(19) United States
(12) Patent Application Publication
(10) Pub. No.: US 2019/0303757 A1
(43) Pub. Date: Oct. 3, 2019

(54) WEIGHT SKIPPING DEEP LEARNING ACCELERATOR

(71) Applicant: MediaTek Inc., Hsinchu (TW)

(72) Inventors: Wei-Ting Wang, Hsinchu (TW); Han-Lin Li, Hsinchu (TW); Chih Chung Cheng, Hsinchu (TW); Shao-Yu Wang, Hsinchu (TW)

(21) Appl. No.: 16/221,295

(22) Filed: Dec. 14, 2018

Related U.S. Application Data
(60) Provisional application No. 62/649,628, filed on Mar. 29, 2018.

(51) Int. Cl. G06N 3/08; G06F 9/50; G06N 3/063; G06F 9/38

(52) U.S. Cl. CPC G06N 3/08; G06F 9/3877; G06N 3/063; G06F 9/5027

(57) ABSTRACT

A deep learning accelerator (DLA) includes processing elements (PEs) grouped into PE groups to perform convolutional neural network (CNN) computations, by applying multi-dimensional weights on an input activation to produce an output activation. The DLA also includes a dispatcher which dispatches input data in the input activation and non-zero weights in the multi-dimensional weights to the processing elements according to a control mask. The DLA also includes a buffer memory which stores the control mask which specifies positions of zero weights in the multi-dimensional weights. The PE groups generate output data of respective output channels in the output activation, and share a same control mask specifying same positions of the zero weights.

### CROSS-REFERENCE TO RELATED APPLICATIONS

This application claims the benefit of U.S. Provisional Application No. 62/649,628 filed on Mar. 29, 2018, the entirety of which is incorporated by reference herein.

### TECHNICAL FIELD

Embodiments of the invention relate to architecture for deep learning computing.

### BACKGROUND

Deep learning has gained wide acceptance for its superior performance in the fields of computer vision, speech recognition, natural language processing, bioinformatics, and the like. Deep learning is a branch of machine learning that uses artificial neural networks containing more than one hidden layer. One type of artificial neural network, called a convolutional neural network (CNN), has been used by deep learning over large data sets such as image data.

The workload of neural network computations is intensive. Most neural network computations involve multiply-and-add computations. For example, the core computation of a CNN is convolution, which involves a high-order nested loop. For feature extraction, a CNN convolves input image pixels with a set of filters over a set of input channels (e.g., red, green and blue), followed by nonlinear computations, down-sampling computations, and class scores computations. The computations have been shown to be highly resource-demanding. Thus, there is a need for improvement in neural network computing to increase system performance.

### SUMMARY

In one embodiment, a deep learning accelerator (DLA) is provided for performing deep learning operations. The DLA includes processing elements (PEs) grouped into PE groups to perform convolutional neural network (CNN) computations, by applying multi-dimensional weights on an input activation to produce an output activation. The DLA further includes a dispatcher which dispatches input data in the input activation and non-zero weights in the multi-dimensional weights to the processing elements according to a control mask. The DLA further includes a buffer memory which stores the control mask which specifies positions of zero weights in the multi-dimensional weights. The PE groups generate output data of respective output channels in the output activation, and share a same control mask specifying same positions of the zero weights.

In another embodiment, a method is provided for accelerating deep learning operations. The method comprises: grouping processing elements into PE groups, each PE group to perform CNN computations by applying multi-dimensional weights on an input activation. The method further comprises: dispatching input data in the input activation and non-zero weights in the multi-dimensional weights to the PE groups according to a control mask. The control mask specifies positions of zero weights in the multi-dimensional weights, and the PE groups share a same control mask specifying same positions of the zero weights. The method further comprises: generating, by the PE groups, output data of respective output channels in an output activation.

The embodiments of the invention enable efficient convolution computations by selecting an operation mode suitable for the input size. The multipliers in the system are shared by different operation modes. Advantages of the embodiments will be explained in detail in the following descriptions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a deep learning accelerator according to one embodiment.

FIG. 2 illustrates an arrangement of processing elements for performing CNN computations according to one embodiment.

FIGS. 3A, 3B and 3C illustrate patterns of zero weights for CNN computations according to some embodiments.

FIG. 4 illustrates skipped weights in fully-connected computations according to one embodiment.

FIG. 5 is a flow diagram illustrating a method for deep learning operations according to one embodiment.

FIG. 6 illustrates an example of a system in which embodiments of the invention may operate.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and method for skipping weights in neural network computations to reduce workload. The skipped weights may be the weights used in a fully-connected (FC) neural network, a convolutional neural network (CNN), or other neural networks that use weights in the computations. A weight may be skipped when its value is zero (referred to as “zero weight”), or when it is to be multiplied only by a zero value (e.g., a zero-value input). Skipping weights can reduce the neural network memory bandwidth, because it is unnecessary to read the skipped weights from the memory. Skipping weights can also reduce computational costs, because it is unnecessary to perform multiplications on zero weights. In one embodiment, the skipped weights are chosen or arranged such that the software and hardware overhead for controlling the weight skipping is optimized.

Before describing the hardware architecture for deep learning neural networks, it may be useful to describe some terminologies. A deep learning neural network may include a combination of CNN layers, batch normalization (BN) layers, rectifier linear unit (ReLU) layers, FC layers, pooling layers, softmax layers, etc. The input to each layer is called an input activation, and the output is called an output activation. An input activation typically includes multiple input channels (e.g., C input channels), and an output activation typically includes multiple output channels (e.g., N output channels).

In an FC layer, every input channel of the input activation is linked to every output channel of the output activation by a weighted link. The data of C input channels in an input activation are multiplied by multi-dimensional weights of dimensions (C×N) to generate output data of N output channels in an output activation.

A ReLU layer performs the function of a rectifier; e.g., a rectifier having a threshold at zero such that the function outputs a zero when an input data value is equal to or less than zero.

A CNN layer performs convolution on input data and a set of filter weights. Each filter used in a CNN layer is typically smaller in height and width than the input data. For example, a filter may be composed of 5×5 weights in the width dimension (W) and the height (H) dimension; that is, five weights along the width dimension and five weights along the height dimension. The input activation (e.g., an input image) to a CNN layer may have hundreds or thousands or more pixels in each of the width and the height dimensions, and may be subdivided into tiles (i.e., blocks) for convolution operations. In addition to width and height, an input image has a depth dimension, which is also called the number of input channels (e.g., the number of color channels in the input image). Each input channel may be filtered by a corresponding filter of dimensions H×W. Thus, an input image of C input channels may be filtered by a corresponding filter having multi-dimensional weights C×H×W. During a convolution pass, a filter slides across the width and/or height of an input channel of the input image and dot products are computed between the weights and the image pixel values at any position. As the filter slides over the input image, a 2D output feature map generated. The output feature map is a representation of the filter response at every spatial position of the input image. Different output feature maps can be used to detect different features in the input image. N output feature maps (i.e., N output channels of an output activation) are generated when N filters of dimensions C×H×W are applied to an input image of C input channels. Thus, a filter weight for a CNN layer can be identified by a position with coordinates (N, H, W, C), where the position specifies the corresponding output channel, the height coordinate, the width coordinate and the corresponding input channel of the weight.

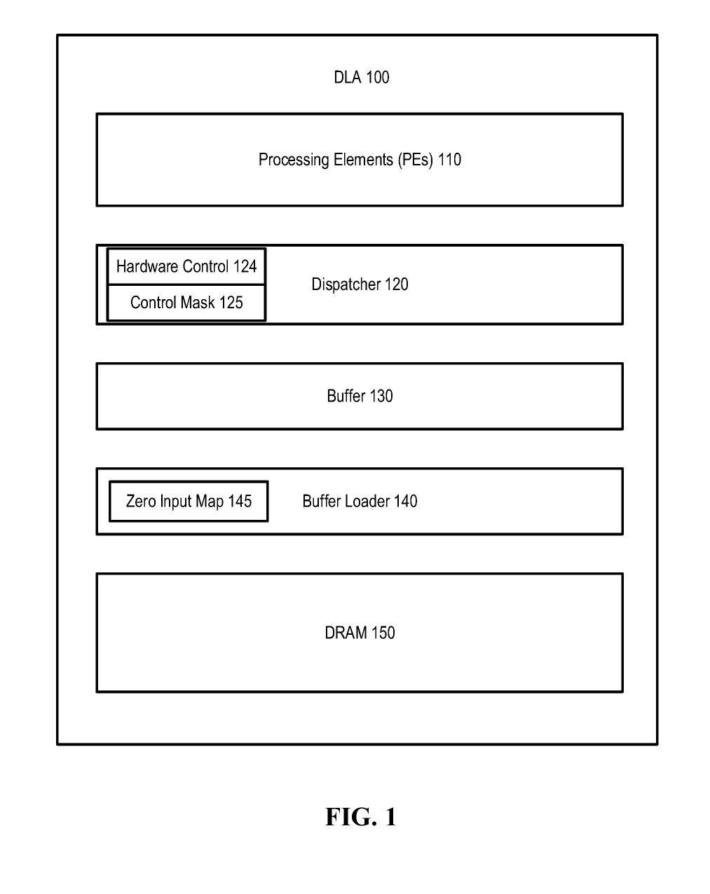

FIG. 1 is a deep learning accelerator (DLA) 100 that supports weight skipping neural network computations according to one embodiment. The DLA 100 includes multiple processing elements (PEs) 110, each of which includes at least one multiply-and-accumulate (MAC) circuit (e.g., a multiplier connected to an adder) to perform multiplications and additions. Operations of the PEs 110 are performed on the input data and weights dispatched by a dispatcher 120. When the DLA 100 performs neural network computations, the dispatcher 120 dispatches weights to the PEs 110 according to a control mask 125, which specifies the positions of zero weights. The zero weights are those weights to be skipped in the computations performed by the MACs in the PEs 110; for example, zero weights used in multiplications can be skipped. In one embodiment, the dispatcher 120 includes a hardware controller 124 which performs read access to the zero weights positions stored in the control mask 125.

In one embodiment, the control mask 125 specifies positions of the zero weights by identifying a given input channel of the multi-dimensional weights as being zero values. In another embodiment, the control mask 125 specifies positions of the zero weights by identifying a given height coordinate and a given width coordinate of the multi-dimensional weights as being zero values. In yet another embodiment, the control mask 125 specifies positions of the zero weights by identifying a given channel, a given height coordinate and a given width coordinate of the multi-dimensional weights as being zero values.

The DLA 100 further includes a buffer 130, which may be a Static Random Access Memory (SRAM) unit for storing input data and weights. A buffer loader 140 loads the input data and weights from a memory, such as a Dynamic Random Access Memory (DRAM) 150. It is understood that alternative volatile or non-volatile memory devices may be used instead of the SRAM buffer 130 and/or the DRAM memory 150. In one embodiment, the buffer loader 140 includes a zero input map 145, which indicates the positions of zero-value input data in an input activation and the positions of nonzero input data in the input activation.

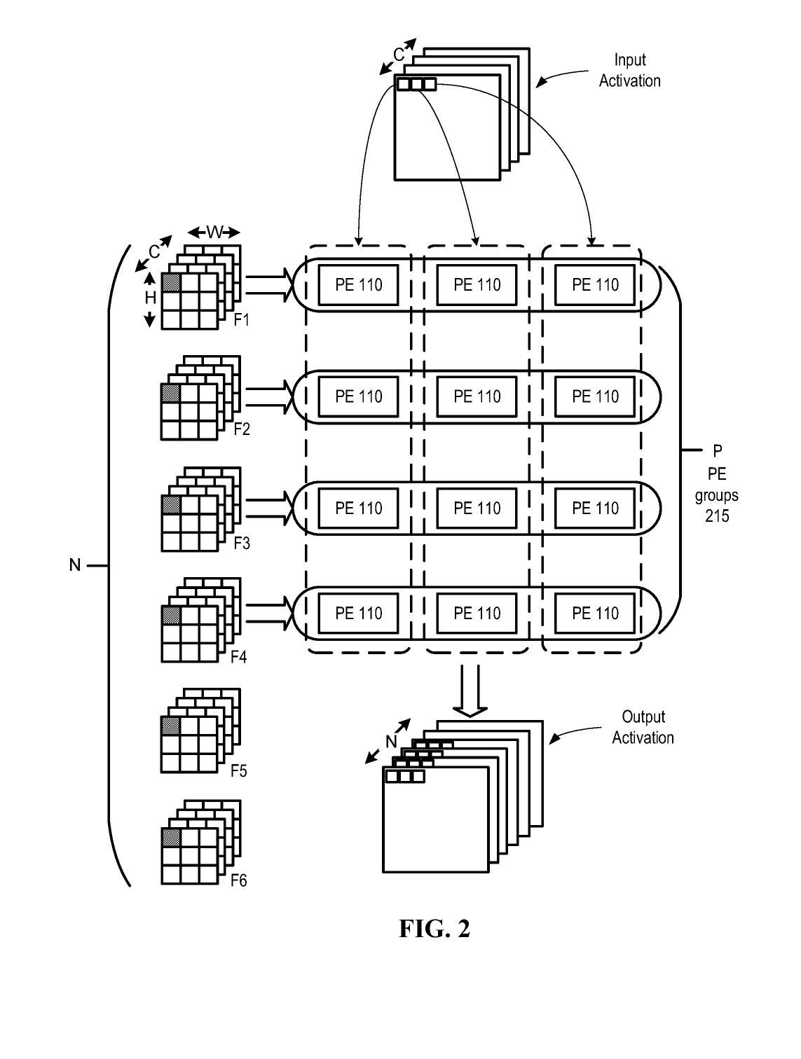

FIG. 2 illustrates an arrangement of the PEs 110 for performing CNN computations according to one embodiment. In this example, the DLA 100 (FIG. 1) includes twelve PEs 110. Furthermore, the input activation has four input channels (C=4), and the output activation has six output channels (N=6). There are six three-dimensional (3D) filters (F1-F6), each having dimensions (H×W×C=3×3×4), for the corresponding six output channels. The PEs 110 are grouped into P numbers of PE groups 215; in this example P=4. The PE groups 215 generate output data of respective output channels in the output activation; that is, each PE group 215 is mapped to (generates output data of) an output channel of the output activation. Furthermore, the PE groups 215 share the same control mask, which specifies the same positions of zero weights in F1-F4.

In this example, the PEs 110 in a first time period performs CNN computations using filter weights of F1-F4 to generate the corresponding four output channels, and in a second time period using filters weights F5 and F6 to generate the next two output channels of the output activation. A control mask specifies the positions of zero-weights in F1, F2, F3 and F4, the four filters used for CNN computations by the four PE groups 215. In this example, each of F1-F4 has a zero weight at the top left corner (shown as a shaded square) of the first input channel; thus, the control mask may specify (H, W, C)=(1, 1, 1) to be a zero weight. When the dispatcher 120 (FIG. 1) dispatches the weights of F1-F4 to the PE groups 215 for CNN computations, the dispatcher 120 skips dispatching the weights at the (1, 1, 1) position for all four output channels. That is, the dispatcher 120 dispatches nonzero weights to the PE groups 215, without dispatching the zero weights to the PE groups 215 for CNN computations.

Compared to conventional CNN computation systems in which filters across different output channels have different zero positions, the shared control mask described herein can significantly reduce the complexity of the control hardware for identifying zero weights and controlling the weight skipping dispatch. In the embodiments described herein, the number of PE groups 215 (which is the same as the number of 3D filters) sharing the same control mask is adjustable to satisfy a performance objective. When all of the 3D filters (six in this example) use the same control mask, the overhead in the control hardware may be minimized. However, if the CNN performance degrades due to the same control mask imposed on the filters of all output channels, the number of these filters sharing the same control mask may be adjusted accordingly. The embodiments described herein allow a subset (P) of the filters using the same control mask, where P≤N, (N being the number of output channels, which is also the number of 3D filters). That is, the number of PE groups is less than or equal to the number of output channels in the output activation.

In one embodiment, the PEs 110 in the same PE group 215 may operate on different portions of the input activation in parallel to produce output data of an output channel. The PEs 110 in different PE groups 215 may use corresponding filters to operate on the same portion of the input activation in parallel to produce output data of corresponding output channels.

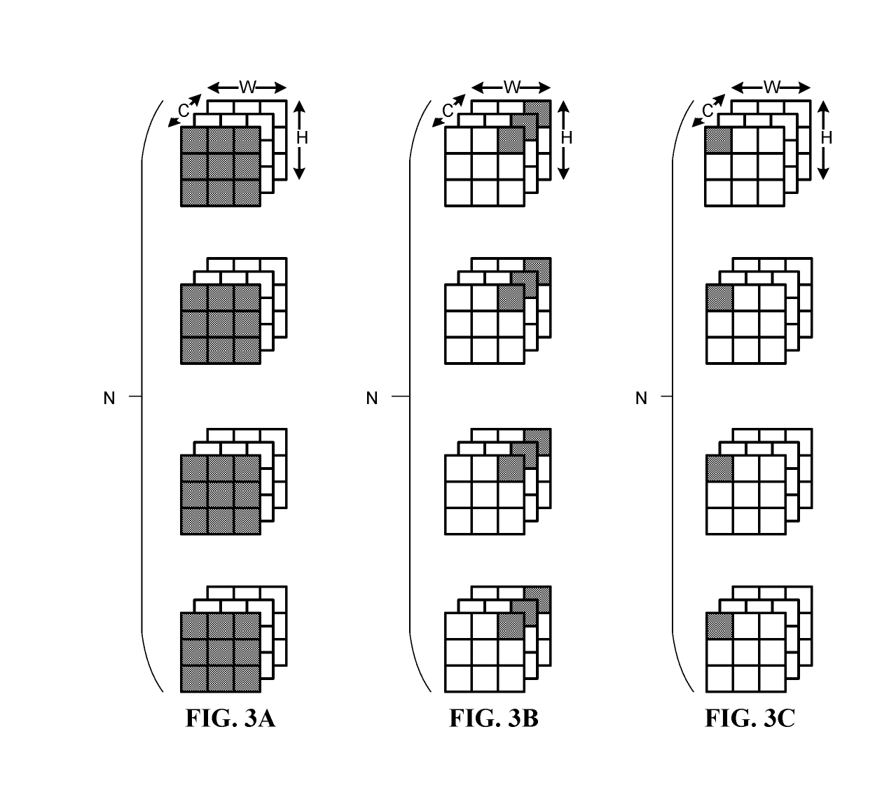

FIGS. 3A, 3B and 3C illustrate patterns of zero weights for CNN computations according to some embodiments. In the examples of FIGS. 3A, 3B and 3C, H=W=C=3, and N=4. FIG. 3A is a diagram illustrating a first zero-weight pattern shared by filters across a set of output channels. The first zero-weight pattern is used in the channel-wise weight skipping, in which the weights of the first input channel across the height (H) and the width (W) dimensions are zeros for the different output channels. The zero weights in each input channel are shown in FIG. 3A as a layer of shaded squares. The first zero-weight pattern is described by a corresponding control mask. The control mask may specify that C=1, which means that the weights in the specified coordinate positions for the set of output channels (e.g., P output channels) are zero values. In one embodiment, the control mask may specify the positions of zero weights as (H, W, C)=(x, x, 1), where x means “don't care.” The dispatcher 120 may skip dispatching the MAC operations that use those zero weights specified in the control mask.

FIG. 3B is a diagram illustrating a second zero-weight pattern shared by filters across a set of output channels. The second zero-weight pattern is used in the point-wise weight skipping, in which the weights of a given (H, W) position across the input channel dimension (C) are zeros for the set of output channels. The zero weights are shown in FIG. 3B as shaded squares. The second zero-weight pattern is described by a corresponding control mask. The control mask may specify that (H, W)=(1, 3), which means that the weights in the specified coordinate positions for the set of output channels (e.g., P output channels) are zero values. In one embodiment, the control mask may specify the positions of zero weights as (H, W, C)=(1, 3, x), where x means “don't care.” The dispatcher 120 may skip dispatching the MAC operations that use those zero weights specified in the control mask.

FIG. 3C is a diagram illustrating a third zero-weight pattern shared by filters across a set of output channels. The third zero-weight pattern is used in the shape-wise weight skipping, in which the weights of a given (H, W, C) position are zeros for the set of output channels. The zero weights are shown in FIG. 3C as shaded squares. The third zero-weight pattern is described by a corresponding control mask. The control mask may specify that (H, W, C)=(1, 1, 1), which means that the weights in the specified coordinate positions for different output channels (e.g., P output channels) are zero values. The dispatcher 120 may skip dispatching the MAC operations that use those zero weights specified in the control mask.

The examples of FIGS. 3A, 3B and 3C show that the control mask can be simplified from tracking zero weights of four dimensions (N, H, W, C) to fewer than four dimensions (one dimension in FIG. 3A, two dimensions in FIG. 3B and three dimensions in FIG. 3C) in the computations of each CNN layer. The uniform zero weight patterns across the P output channels remove one dimension (i.e., the output channel dimension (N)) from the control mask shared by the P groups of PEs. Accordingly, referring back to FIG. 1, the hardware controller 124 which reads from the control mask 125 for the dispatcher 120 can also be simplified.

In the embodiment of FIG. 1, the buffer loader 140 first loads input data from the DRAM 150 into the buffer 130. Some of the input data value may be zero, for example, as a result of ReLU operations in a previous neural network layer. For FC computations, each zero-value input data results in the multiplication output equal to zero. Thus, the corresponding weights to be multiplied by the zero input may be marked as “skipped weights.”

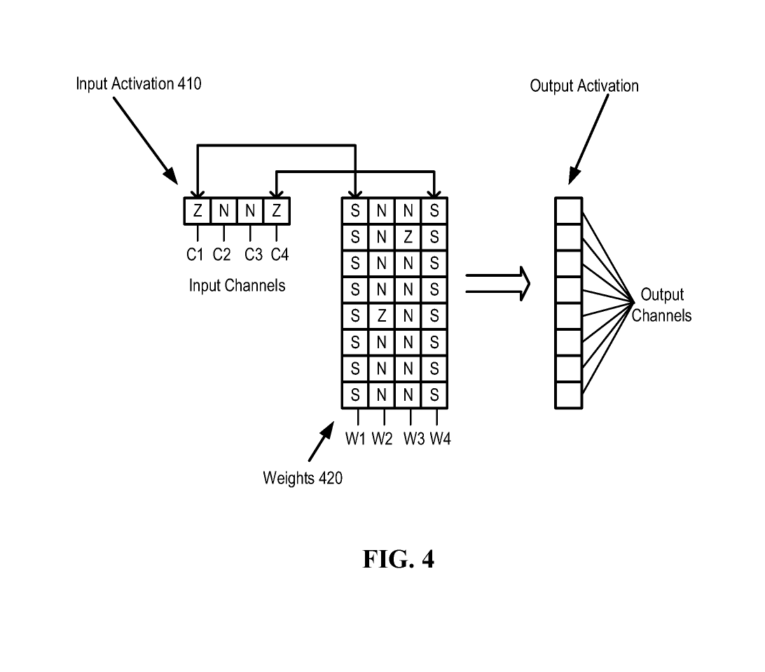

FIG. 4 illustrates skipped weights in FC computations according to one embodiment. Referring to FIG. 4, the buffer loader 140 reads an input activation 410 which includes multiple input channels (e.g., C1, C2, C3 and C4). The data in each input channel is to be multiplied by corresponding weights (e.g., a corresponding column of the two-dimensional weights 420). In this example, after reading the input activation 410, the buffer loader 140 identifies that the data in the input channels (e.g., C1 and C4) are zeros (labeled in FIG. 4 as “Z”), and marks the corresponding weights (e.g., the two columns W1 and W4) as “skipped weights” (labeled as “S”) without loading W1 and W4. In this example, the data in the input channels C2 and C3 are non-zeros (labeled as “N”), so the buffer loader 140 loads the corresponding weights W2 and W3 from the DRAM 150 into the buffer 130. Thus, the buffer loader 140 skips reading (and loading) the weights W1 and W4. Skipping the read access to W1 and W4 reduces memory bus traffic.

After weights W2 and W3 are loaded into the buffer 130, the dispatcher 120 identifies zero weights (labeled in FIG. 4 as “Z”) and non-zero weights (labeled as “N”) in W2 and W3. The dispatcher 120 is to skip dispatching the zero weights to the PEs 110. The dispatcher 120 dispatches the non-zero weights in W2 and W3, together with the input data in the corresponding input channels C2 and C3 to the PEs 110 for MAC operations. By skipping the MAC operations for zero weights that are loaded into the buffer 130, the workload of PEs 110 can be reduced.

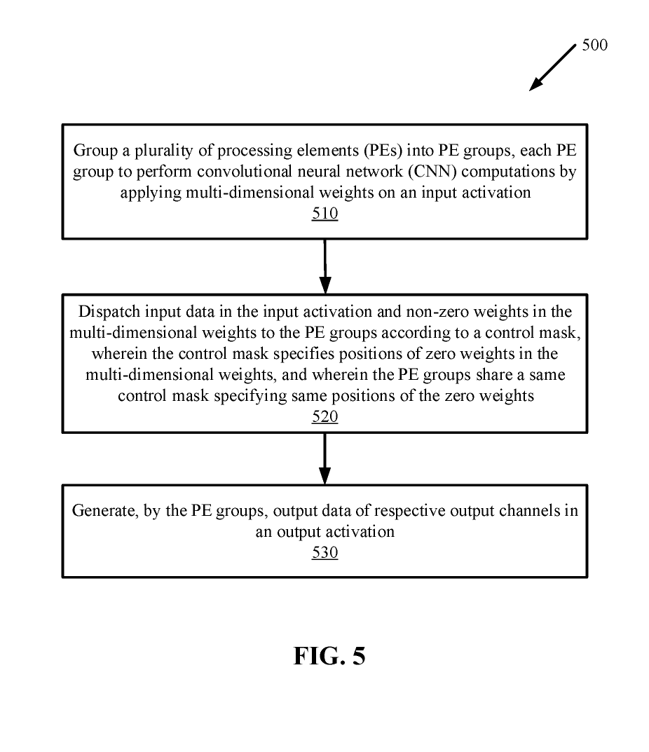

FIG. 5 is a flow diagram illustrating a method 500 for performing deep learning operations according to one embodiment. In one embodiment, the method 500 may be performed by an accelerator (e.g., the DLA 100 of FIG. 1).

The method 500 begins with the accelerator at step 510 groups processing elements (PEs) into PE groups. Each PE group is to perform CNN computations by applying multi-dimensional weights on an input activation. The accelerator includes a dispatcher which, at step 520, dispatches input data in the input activation and non-zero weights in the multi-dimensional weights to the PE groups according to a control mask. The control mask specifies positions of zero weights in the multi-dimensional weights. The PE groups share the same control mask specifying the same positions of the zero weights. The PE groups at step 530 generate output data of respective output channels in an output activation.

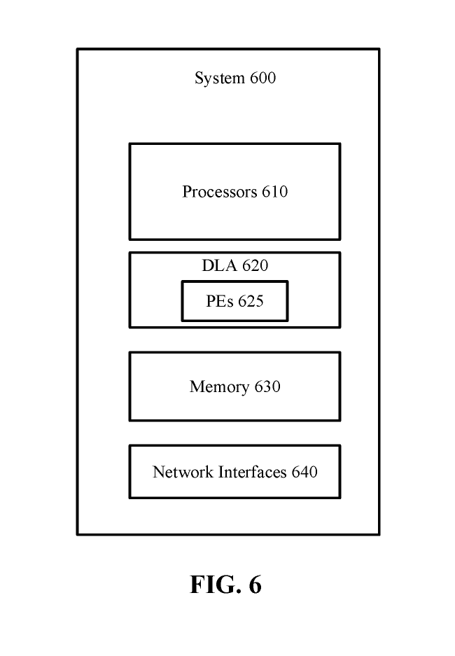

In one embodiment, a non-transitory computer-readable medium stores thereon instructions that, when executed on one or more processors of a system, cause the system to perform the method 500 of FIG. 5. An example of the system is described below with reference to FIG. 6.

FIG. 6 illustrates an example of a system 600 in which embodiments of the invention may operate. The system 600 includes one or more processors (referred to herein as the processors 610), such as one or more central processing units (CPUs), graphics processing units (GPUs), digital signal processors (DSPs), media processors, or other general-purpose and/or special-purpose processing circuitry. The processors 610 are coupled to a DLA 620, which is one embodiment of the DLA 100 of FIG. 1. The DLA 620 may include a plurality of hardware components, such as processing elements (PEs) 625, as well as other hardware components shown in the DLA 100 of FIG. 1. Each of the PEs 625 further includes arithmetic components, such as one or more of: multipliers, adders, accumulators, etc. The PEs 625 may be arranged as one or more groups for performing neural network computations described above in connection with FIGS. 1-5. In one embodiment, the output of the DLA 620 may be sent to a memory 630, and may be further processed by the processors 610 for various applications.

The memory 630 may include volatile and/or non-volatile memory devices such as random access memory (RAM), flash memory, read-only memory (ROM), etc. The memory 630 may be located on-chip (i.e., on the same chip as the processors 610) and include caches, register files and buffers made of RAM devices. Alternatively or additionally, the memory 630 may include off-chip memory devices which are part of a main memory, such as dynamic random access memory (DRAM) devices. The memory 630 may be accessible by the PEs 625 in the DLA 620. The system 600 may also include network interfaces for connecting to networks (e.g., a personal area network, a local area network, a wide area network, etc.). The system 600 may be part of a computing device, communication device, or a combination of computing and communication device.

The operations of the flow diagram of FIG. 5 have been described with reference to the exemplary embodiments of FIGS. 1 and 6. However, it should be understood that the operations of the flow diagram of FIG. 5 can be performed by embodiments of the invention other than the embodiments discussed with reference to FIGS. 1 and 6, and the embodiments discussed with reference to FIGS. 1 and 6 can perform operations different than those discussed with reference to the flow diagram. While the flow diagram of FIG. 5 shows a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A deep learning accelerator, comprising:
a plurality of processing elements (PEs) grouped into PE groups to perform convolutional neural network (CNN) computations by applying multi-dimensional weights on an input activation to produce an output activation;
a dispatcher to dispatch input data in the input activation and non-zero weights in the multi-dimensional weights to the processing elements according to a control mask; and
a buffer memory to store the control mask which specifies positions of zero weights in the multi-dimensional weights;
wherein the PE groups generate output data of respective output channels in the output activation, and share a same control mask specifying same positions of the zero weights.

2. The deep learning accelerator of claim 1, wherein the control mask specifies positions of the zero weights by identifying a given input channel of the multi-dimensional weights as being zero values.

3. The deep learning accelerator of claim 1, wherein the control mask specifies positions of the zero weights by identifying a given height coordinate and a given width coordinate of the multi-dimensional weights as being zero values.

4. The deep learning accelerator of claim 1, wherein the control mask specifies positions of the zero weights by identifying a given channel, a given height coordinate and a given width coordinate of the multi-dimensional weights as being zero values.

5. The deep learning accelerator of claim 1, wherein each PE group includes multiple processing elements, which perform the CNN computations in parallel on different portions of the input activation.

6. The deep learning accelerator of claim 1, wherein the number of PE groups is less than the number of output channels in the output activation.

7. The deep learning accelerator of claim 1, wherein the number of PE groups is equal to the number of output channels in the output activation.

8. The deep learning accelerator of claim 1, wherein the processing elements are further operative to perform fully-connected (FC) neural network computations, the deep learning accelerator further comprising:
a buffer loader operative to read FC input data from a memory, and to selectively read FC weights from the memory according to values of the FC input data.

9. The deep learning accelerator of claim 8, wherein the buffer loader is operative to:
read a first subset of the FC weights from the memory without reading a second subset of the FC weights from the memory, the first subset corresponding to a nonzero FC input channel and the second subset corresponding to a zero FC input channel.

10. The deep learning accelerator of claim 8, wherein the dispatcher is further operative to:
identify zero FC weights in the first subset; and
dispatch nonzero FC weights in the first subset to the processing elements, without dispatching the second subset of the FC weights and the zero FC weights to the processing elements for FC neural network computations.

11. A method for accelerating deep learning operations, comprising:
grouping a plurality of processing elements (PEs) into PE groups, each PE group to perform convolutional neural network (CNN) computations by applying multi-dimensional weights on an input activation;
dispatching input data in the input activation and non-zero weights in the multi-dimensional weights to the PE groups according to a control mask, wherein the control mask specifies positions of zero weights in the multi-dimensional weights, and wherein the PE groups share a same control mask specifying same positions of the zero weights; and
generating, by the PE groups, output data of respective output channels in an output activation.

12. The method of claim 11, wherein the control mask specifies positions of the zero weights by identifying a given input channel of the multi-dimensional weights as being zero values.

13. The method of claim 11, wherein the control mask specifies positions of the zero weights by identifying a given height coordinate and a given width coordinate of the multi-dimensional weights as being zero values.

14. The method of claim 11, wherein the control mask specifies positions of the zero weights by identifying a given channel, a given height coordinate and a given width coordinate of the multi-dimensional weights as being zero values.

15. The method of claim 11, further comprising:
performing the CNN computations in parallel on different portions of the input activation by multiple processing elements in each PE group.

16. The method of claim 11, wherein the number of PE groups is less than the number of output channels in the output activation.

17. The method of claim 11, wherein the number of PE groups is equal to the number of output channels in the output activation.

18. The method of claim 11, wherein the processing elements are further operative to perform fully-connected (FC) neural network computations, the method further comprising:
reading FC input data from a memory; and
selectively reading FC weights from the memory according to values of the FC input data.

19. The method of claim 18, further comprising:
reading a first subset of the FC weights from the memory without reading a second subset of the FC weights from the memory, the first subset corresponding to a nonzero FC input channel and the second subset corresponding to a zero FC input channel.

20. The method of claim 18, further comprising:
identifying zero FC weights in the first subset; and
dispatching nonzero FC weights in the first subset to the processing elements without dispatching the second subset of the FC weights and the zero FC weights to the processing elements for FC neural network computations.
